(19) United States
(12) Patent Application Publication
(10) Pub. No.: US 2003/0140339 A1
(43) Pub. Date: Jul. 24, 2003

(54) Method and apparatus to maintain service interoperability during software replacement

(76) Inventors: Thomas E. Shirley, Bartlett, IL (US); Brian J. Moore, Palatine, IL (US); Paul D. Steinberg, Bartlett, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/054,174

(22) Filed: Jan. 18, 2002

(51) Int. Cl. G06F 9/44; G06F 15/173

(52) U.S. Cl. 717/171; 717/170; 709/223

(57) ABSTRACT

A method and apparatus for maintaining service interoperability in a communications network during software replacement in a component of the communications network having a cluster of devices. The method and apparatus generally involve the use of a name service in the devices to control the binding of client applications requesting logically de-centralized services to corresponding local services on the devices operating under the same software version. The name services utilize a database or registry of information relating to the logically de-centralized local services and logically centralized global services to determine the appropriate local or global service to which to bind the requesting client application. The database or registry may include information indicating the software release under which a local service is operating for use in binding the requesting client application to the appropriate local service.

### TECHNICAL FIELD

The present invention relates generally to software conversion in clustered hardware architectures, such as those employed in mobile communication systems, and more particularly to a method and apparatus for maintaining service interoperability between entities within a clustered architecture during an upgrade or downgrade of software for the system.

### BACKGROUND

In a clustered architecture, multiple entities are used to provide a set of services for client application software. One example of an application of a clustered architecture is in a typical high-availability cellular environment. In a typical cellular environment, a component of the environment, such as a base transceiver station (BTS), may utilize a cluster including an active processor that normally performs call processing, and a standby processor to replace the active processor in the event of fault or failure. During operations, the processor that is processing call traffic is called the primary processor while the standby processor is called the secondary processor. If a fault or failure occurs in the primary processor, or in the event of a software upgrade or downgrade, the secondary processor must take over the operations of the primary with a minimal loss of BTS' services, including call processing.

In the cellular environment, the BTS may be responsible for the coordination and control of hundreds of wireless connections. If the primary processor is unable to continue its operations, either due to a planned graceful shutdown, or an abnormal condition, the clustered architecture facilitates the transition to the secondary processor to take control quickly and with the proper data to save the wireless connections.

Keeping with the example of a BTS in a cellular environment, a clustered architecture may be implemented to distribute the load of wireless connection across multiple hardware devices. The BTS may include multiple processors, each capable of handling multiple wireless connections. As the connections are established at the BTS, they may be directed through the processor with the greatest excess capacity in order to maximize the throughput of the BTS and minimize delays in processing cellular telephone calls.

During normal operations, the components of the clustered architecture interact to provide continuous service for applications such as the BTS of the cellular environment. From time to time, however, a need exists to replace the software of the components of the clustered architecture. The replacement software may be either a newer version (a software upgrade) or an older version (a software downgrade). There are three generally used industry practices for software replacement. The first approach involves installing the software release on all the components and simultaneously rebooting all the components on the release. This approach causes the maximum disruption of service to the environment in which the clustered architecture is implemented and, therefore, is not preferred in environments where users expect continuous service.

The second approach, known as a split-mode conversion, involves the conversion of half of the components of the clustered architecture at a time. In this approach, half of the components are removed from service, the components are initialized on the updated software release, any transient data is synchronized between the old and the new releases, and operations are then switched to the updated software release. After one half of the components are converted, the process is repeated for the remaining components.

The third approach, known as a rolling conversion, iteratively removes each component from service to update the software, and returns the component to service on the updated release. When the component comes into service on the updated release, it immediately begins to provide service. This process continues until all the components are converted to the updated release. In contrast to the first approach, both the split-mode and rolling upgrade approaches have the potential to provide downtime-free software replacement.

Clustered architectures provide sets of services that appear to client applications to be ubiquitous. The services can include any processing functions offered by the cluster architecture to support the client applications, such as data access functions, processing functions, control functions, and the like. In an application such as the BTS of the cellular environment, these services may include message passing, configuration database access, persistent data access, state data access, and checkpointing. Each component of the cluster has client applications that request services that may be provided by the same component or by other components of the cluster. During software conversions using either split-mode or rolling update approaches, there are periods of time where components of the cluster operate under different software releases that may not be compatible. Incompatibility arises when the different software releases use different logical or physical database configurations, or exchange data between clients and services in different formats, such that the version of the interface between the client applications and the services changes.

In previously known clustered architecture applications, all services are treated as logically centralized services wherein all client applications and services access the same logical or physical database configurations, or exchange data in the same formats, during a software conversion. During the conversion, a client application operating under the new release may require services provided on a component operating under an incompatible old software release. In such instances, additional code is required at one of the components, typically in the one with the later software release, to ensure compatibility between the client application and the service so that the service appears to the client application to be provided by compatible software.

Despite the traditional approach to software conversion of a clustered architecture, some or all services may be logically de-centralized such that performance of the services may be distributed across the components of the cluster. For example, configuration database information may be component specific such that the configuration information for one component may be converted to the new format as stored for access by clients and services operating under the new software release without affecting the client applications or services operating under the old software release. Distributed in this way, client applications may be able to obtain services operating under compatible software releases throughout the conversion process, while minimizing or eliminating the need for additional code to ensure compatibility.

Thus, there is a need for a method and apparatus for segregating logically decentralized services based on software compatibility and binding requesting client applications to compatible services during a software conversion, thereby reducing the additional coding necessary to ensure compatibility between software releases during the software conversion.

### BRIEF DESCRIPTION OF THE DRAWINGS

The features and advantages of the present invention will become more apparent from the following detailed description of the preferred embodiments of the invention taken in conjunction with the drawings.

FIG. 1 is a diagram of a typical wireless communication system suitable for use in accordance with the teachings of the present invention.

FIG. 2 is a block diagram of a cluster of devices in which the method and apparatus in accordance with the teachings of the present invention may be implemented.

FIG. 3 is a block diagram of an exemplary device of the cluster of FIG. 2.

FIG. 4 is a block diagram of the cluster of devices of FIG. 2 utilizing the method and apparatus in accordance with the teachings of the present invention during a software conversion process.

FIG. 5 is a flow diagram of a process for performing software conversion of the cluster of devices of FIG. 2 utilizing the method and apparatus in accordance with the teachings of the present invention.

FIG. 6 is a flow diagram of a process for registering services in the cluster of devices of FIG. 2 utilizing the method and apparatus in accordance with the teachings of the present invention.

FIG. 7 is a flow diagram of a process for processing requests for services in the cluster of devices of FIG. 2 utilizing the method and apparatus in accordance with the teachings of the present invention during a software conversion.

FIGS. 8a-e is series of block diagrams illustrating a rolling update software conversion of the cluster of devices of FIG. 2 utilizing the method and apparatus in accordance with the teachings of the present invention.

FIG. 9 is a block diagram illustrating a split-mode update software conversion of the cluster of devices of FIG. 2 utilizing the method and apparatus in accordance with the teachings of the present invention.

FIG. 10 is a block diagram illustrating an alternative final state after the software conversion of FIGS. 8a-e.

FIG. 11 is a block diagram illustrating an alternative intermediate state of the rolling update software conversion of FIGS. 8a-e.

FIG. 12 is a block diagram illustrating another alternative intermediate state of the rolling update software conversion of FIGS. 8a-e.

FIG. 13 is a block diagram illustrating a further alternative intermediate state of the rolling update software conversion of FIGS. 8a-e.

### DETAILED DESCRIPTION

The present invention provides a method and apparatus that addresses the above-mentioned problems by providing local domains into which local services are grouped during a software conversion for providing services to client applications operating under compatible software versions. The local domains are implemented via name services that bind client applications requesting services to the appropriate compatible services. The method and apparatus generally involve the use of a name service in devices of a cluster of devices to control the binding of client applications requesting logically de-centralized services to corresponding local services on the devices operating under the same software version. The name services utilize a database or registry of information relating to the logically de-centralized local services and logically centralized global services to determine the appropriate local or global service to which to bind the requesting client application. The database or registry may include information indicating the software release under which a local service is operating for use in binding the requesting client application to the appropriate local service. The method may generally further involve de-registering the local services and corresponding old software version information from the database or registry and reregistering the local services during the software replacement with information indicating a new software version under which the local services operate.

The method and apparatus of the present invention reduce the amount of code that must be added to local services for execution during the conversion process in order to maintain interoperability between client applications and services operating under otherwise incompatible software versions. The method may be implemented on any computer system, or for example, on any computer system located at an appropriate location within a wireless communication system, for instance, at a base transceiver station. It will be noted, however, that while the description of the preferred embodiment detailed below references a wireless cellular system, it will be recognized by those skilled in the art that the present invention may be applied to any computer system using a clustered architecture during application upgrades or downgrades without loss of critical functionality.

Furthermore, while the below embodiment is in reference to a wireless communication system with four devices, it will be recognized by those skilled in the art that the system may be implemented by any clustered architecture with multiple entities, such as by multiple processors within a single hardware device, by multiple portions of storage within a device, or in any other manner known in the art for using multiple entities, each of which is configured to perform a set of services. Moreover, while the illustrated example is directed towards a Code Division Multiple Access (CDMA) radio access network, the system may be utilized in any mobile switching environment, including for example, a Global System for Mobile Communication (GSM), a General Packet Radio Service (GPRS) system, or a Universal Mobile Telecommunications System (UMTS).

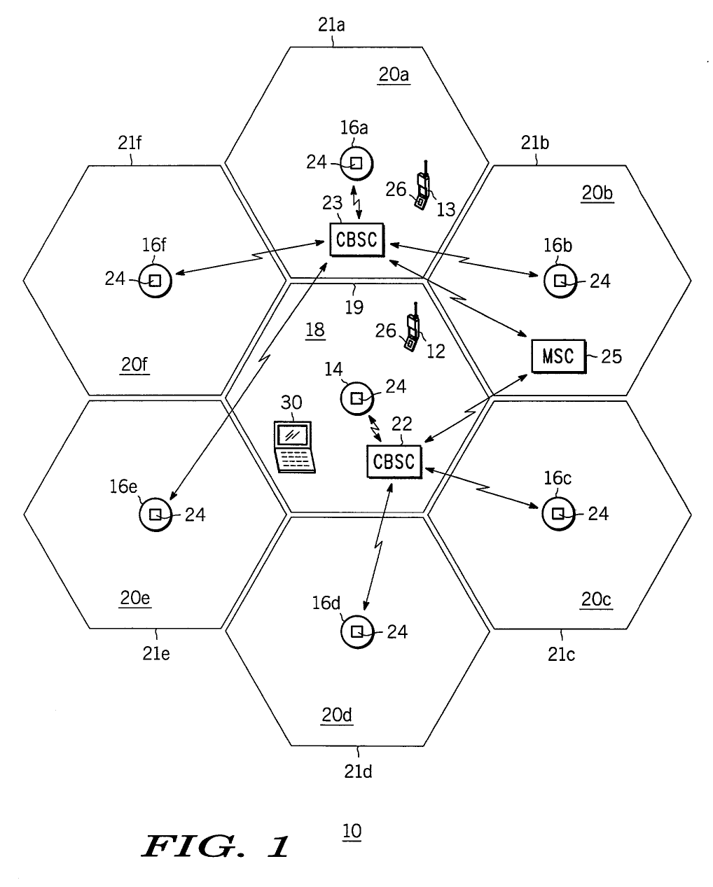

Referring now to the drawings, FIG. 1 illustrates a block diagram of a typical wireless communication system constructed according to the teachings of the present invention and for which the method of the invention is particularly well suited. The communication system 10 has mobile users or units 12 and 13, a first base transceiver station (BTS) 14, and a plurality of surrounding or neighboring base transceiver stations (NBTS) 16a-16f. As generally depicted in FIG. 1, the mobile unit 12 resides at a given time in one cell 18 of the system 10 defined by a sector or subcell 19 that is served by the BTS 14. Each of the NBTS 16a-16f separate respective cell 20a-20f adjacent the cell 18 that are defined by respective boundaries 21a-21f. A centralized base station controller (CBSC) 22 is in communication with the BTS 14 and several of the neighboring NBTS (NBTS 16c-16d). A centralized base station controller (CBSC) 23 is in communication with the other neighboring NBTS (NBTS 16a-16b, and 16e-16f). A mobile switching center (MSC) 25 is in communication with the CBSC 22 and 23.

The system 10 will typically have a large number of mobile users or units 12 and 13 and a plurality of BTSs spread over an area served by the overall system as is known in the art. For convenience of illustration, FIG. 1 only shows two mobile units 12 and 13 and a relatively small number of BTSs including the BTS 14 and the several NBTS 16. Also as is known in the art, the mobile user or units 12 and 13 represent a cellular telephone that can travel with a system user throughout the various cells of the system. The mobile units 12 and 13 can also represent other types of data devices such as a wireless data terminal or phone, videophone, or the like. These types of units transmit data and/or voice signals over the several BTSs of the communication system.

The type of communication system 10 as represented in FIG. 1 can vary within the scope of the present invention, but in one example is a BTS in a Code Division Multiple Access (CDMA) or CDMA 2000 system as is known in the art. Other examples include a GPRS Support Node (GSN) in the GPRS system, a Base Station Controller (BSC) in the GSM system and a Radio Network Controller (RNC) and Node B in the UMTS system. The system 10 may be any communication system that transmits signaling messages and requires accurate delivery and receipt by mobile stations or units 12 and 13. The BTS 14 and the several NBTS 16 each include a transceiver 24 that has a transmitter and a receiver. The transceiver 24 transmits over-the-air (OTA) radio frequency (RF) signals to be received by the mobile units 12 and 13. This type of transmission is well known in the art and will not be described in any greater detail herein, however communications in the communication system 10 may be performed using any standard communication protocol known for exchanging information in a given network, and for performing standard processing function such as error handling. Transceivers 24 receive messages from the mobile unit 12, also by means well known in the art. Each mobile unit 12 and 13 has a transceiver 26 including a transmitter and receiver. The mobile units 12 and 13 communicate with a BTS by transmitting messages via the transceiver 26 on reverse links, and receives messages via the transceiver 26 that are generated by the BTS on forward links.

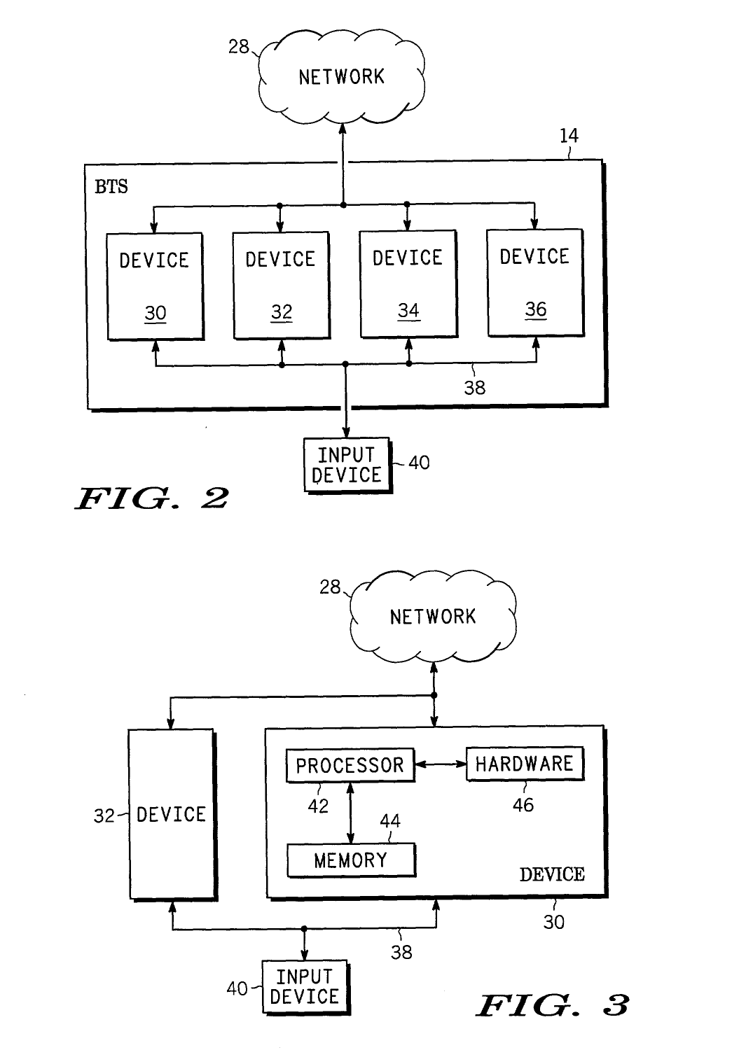

The method of the present invention may be implemented, for example, at the BTS 14 described above having a plurality of devices 30-36 as shown in FIG. 2. The BTS 14 is connected to a network 28, with the devices 30-36 performing the functions of the BTS 14 and communicating with the network 28. The devices 30-36 are also interconnected via an intranet 38 to allow communications and sharing of data and processing functions between the devices 30-36. In addition to communicating with each other and with the network 28, the devices 30-36 may also communicate with an external input device 40 connected via the intranet 38 of the BTS 14. The input device 40 may be capable of transmitting operating instructions, software and/or data to the devices 30-36, and may be a stand-alone computer or operator workstation, a keyboard, an external storage device, a combination thereof, or any other input device known to those skilled in the art.

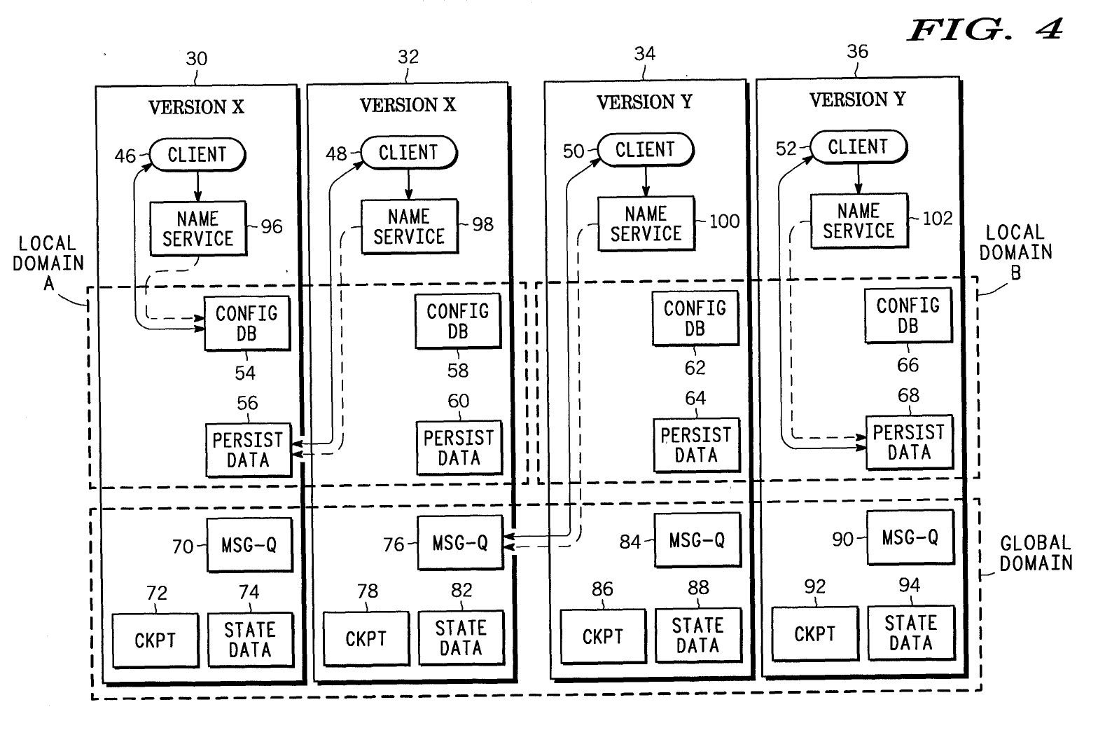

The device 30 shown in FIG. 3, which is exemplary of the devices 30-36, may include a processor 42, internal memory 44, and one or more hardware components 46. Generally, the processor 42 executes application, operating system and network architecture software stored in the memory 44 to, among other things, control the hardware 46. It should be appreciated that although only one processor 42 is shown, the device 30 could include multiple processors 42. Similarly, the memory 44 of the device 30 could include multiple RAMs and multiple ROMs. The RAM(s) and ROM(s) could be implemented as semiconductor memories, magnetically readable memories, optically readable memories, and the like. For example, a memory such as any one, or any suitable combination, of an electrically programmable read only memory (EPROM), an electrically erasable programmable read only memory (EEPROM), a one time programmable read only memory (OTP ROM), a static random access memory (SRAM), FLASH or any other suitable memory element may be connected to the processor 42. Furthermore, the memory(ies) may be embodied in other computer-readable persistent data storage media such as optical media, e.g., CDs, rewritable CDs, DVDs and the like, or magnetic media, e.g., floppy disks, hard drives, zip disks and the like.

Although shown as a single block, the hardware 46 may include any hardware necessary to perform the functions of the device 30. For example, in the BTS 14, the hardware 46 may include one or more of intranet hardware for communications between the devices 30-36 within the BTS 14, switches, routers, hardware for communicating with entities outside the BTS 14 such as the network 28, control processing hardware, hardware for processing communications traffic passing through the BTS 14, and the like. Of course, the hardware 46 contained in a device such as device 30 will vary depending on the particular processing requirements of a given cluster within the communication system.

From time to time, as new software releases are developed, or as needs arise to downgrade to an earlier software release, it is necessary to perform a software conversion of the cluster. To avoid interrupting the services performed by the cluster, a split-mode or rolling approach as discussed above may be implemented wherein the software stored in the memories 44 of one or more of the devices 30-36 are replaced and the new software is executed by the processors 42. The conversion process may be controlled and performed over the network 28 and/or via the input device 40. For example, the input device 40 may deliver the new software to the devices 30-36 along with instructions to store the software in memory 44, to convert data, to cease operations, to restart or reboot the devices 30-36, to initialize the devices 30-36 to begin executing the new software, and to commence executing the new software. In this way, the input device 40 may provide the new software and data necessary for the conversion as well as control the conversion process. Alternatively, the conversion process may be controlled and performed in whole or in part by other components of the communications system via the connection of the network 28 to the devices 30-36 of the BTS 14.

The devices described in FIG. 3 can implement the cluster of devices 30-36 as shown in FIG. 4 that perform the functions of the BTS 14, such as call processing and billing. The devices 30-36 each store and execute one or more client applications 46-52 to perform the functions of the cluster. The logically decentralized services, identified as local services 54-68, are grouped into one or more local domains, such as local domains A and B, based on the software version installed on the devices 30-36. The logically centralized services, identified as global services 70-94, are grouped in a single global domain regardless of their software version. During execution, the clients 46-52 may request services to be performed by one or more local services 54-68 or global services 70-94. The devices 30-36 are connected by an intranet as discussed above, thereby enabling a client such as client 46 of device 30 to obtain services from any of the devices 30-36 in the cluster. This is the normal manner of operation when all the devices 30-36 are operating with the same version of software.

Difficulty and complexity arise when the devices 30-36 operate under different versions of the software, such as during a phased software replacement as shown in FIG. 4 and illustrating an intermediate state wherein devices 34, 36 have been converted to software version Y while devices 30, 32 still operate under software version X. In previously known systems, all services are typically treated as global services with the clients 46-52 receiving services from designated devices 30-36 even if the client and requested services are running under different, incompatible versions of software. As a result, the software typically must include additional code to ensure compatibility between the software versions so that the services, regardless of version of software, appear ubiquitous to the client application.

The method of the present invention reduces the complexity of software and minimizes the need for additional code to ensure compatibility between software versions. The benefits are achieved by identifying logically decentralized local services and grouping the local services into the local domains for access by client applications operating with compatible software versions. The method of the present invention is implemented via name services 96-102 in the devices 30-36 at which the services of the cluster along with their associated domains are registered. The name services 96-102 utilize a single logical database including a registry of the services available in the cluster and the domain in which the services reside. The logical database may also be a single physical database stored at a central location accessed by all the name services or, alternatively, be distributed and stored locally at each device 30-36 for access by the corresponding name services 96-102, respectively. The registry includes information for each service to be used by the name services 96-102 to bind the appropriate service to a requesting client 46-52 for performance of the requested service. The registry may contain information for the services such as indicia identifying the service and its presence in the cluster, an indication of the type of service, either local or global, the software release or interface version for the service, the device on which the service resides, the domain for the service, the operating status of the service, or any other information necessary for the name services 96-102 to bind the requested service to the requesting client. Upon receiving a request for services from one of the clients 46-52, the corresponding name service 96-102 accesses information for the requested service in the registry, and binds the client application to the proper service within the proper domain, possibly via the intranet. It will be appreciated that the local domains constitute a logical grouping of logically de-centralized local services operating under compatible software versions and being accessed by compatible client applications through the name services.

As shown in FIG. 4, devices 30, 32 are operating under software version X while devices 34, 36 are operating under software version Y at some point during a software conversion of the cluster of devices 30-36. The local services 54-60 of devices 30, 32 are grouped together in local domain A, and local services 62-68 of devices 34, 36 are grouped together in local domain B. The logically centralized global services 70-94 are grouped together in a single global domain. The services 54-60 in local domain A, and services 62-68 in local domain B are compatible with client application 46, 48 and client applications 50, 52, respectively. When a client requires a local service to be performed, the corresponding name service for the device determines the appropriate local service in the compatible local domain and binds the local service to the client application for processing of the request for services. In FIG. 4 and the figures that follow, interactions between the client applications and name services, and between the client applications and the requested services, are denoted by the solid arrow lines. The communication of registry information and performance of binding operations are denoted by the dashed arrow lines.

To illustrate, client 46 may request a configuration DB access service. The name service 96 receives the request and determines from the registry of services that the service is provided by the local service 54 in local domain A. The name service binds the local service 54 to the client 46 for processing of the request. Because client 46 and local service 54 both operate under software version X, they are compatible and no additional code is required to process the request during the conversion process. A similar situation exists where client 52 requests service to be provided by local service 68. The request of client 48 for services provided by local service 56 further illustrates that once multiple devices are converted to the new software versions, client applications are again able to obtain services from local services residing on other devices in the cluster operating with compatible software. Name service 98, upon receiving the request for services from client 48, determines that the services are provided by local service 56 of device 30, and binds client 48 to local service 56 via the intranet.

While much of the complexity and additional compatibility code can be eliminated by implementing the method according to the present invention, conditions may exist wherein a client operating under one software version must obtain services from a global service operating under a different software version. In this case, additional code may be necessary to ensure that the service appears ubiquitous to the client application. For example, the request of client 50 for services provided by global service 76 may require additional code either in the global service 76 or on device 34, depending on the order of the conversion process, to ensure compatibility between software version Y of client 50 and software version X of global service 76.

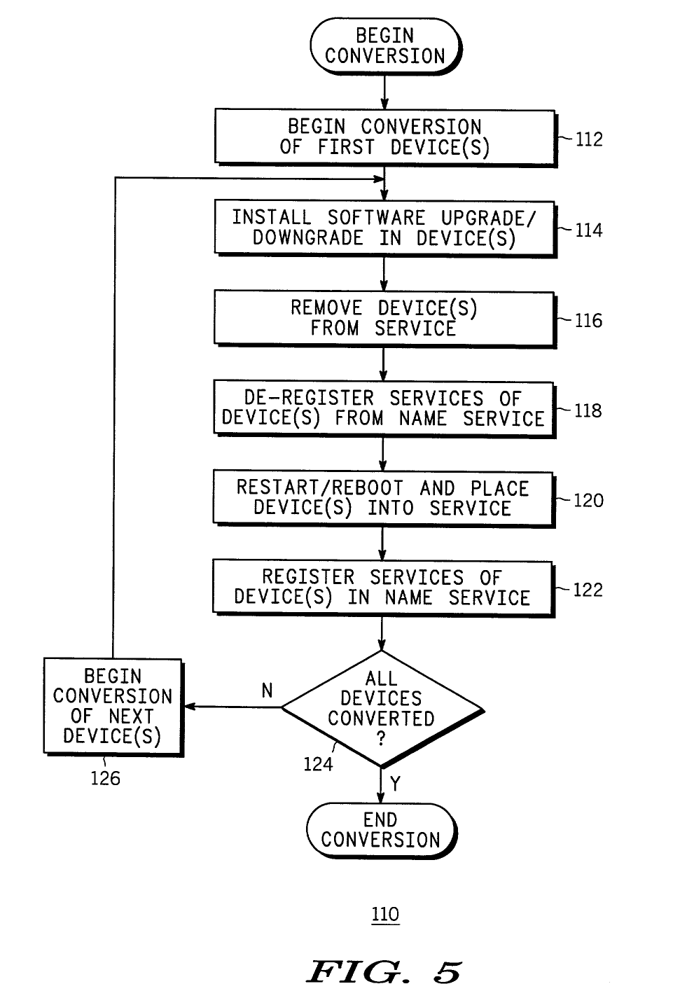

The processes of converting the cluster, registering services in the name services, and processing requests for services in a cluster of devices implementing the method of the present invention will now be discussed in greater detail with reference to the flow diagrams shown in FIGS. 5-7.

FIG. 5 illustrates a flow diagram 110 for converting software on multiple devices in a clustered architecture implementing local and global domains according to the present invention. While components of a cellular environment are discussed in the embodiments disclosed herein, it will be recognized that the method of the present invention may be adapted to any number of clustered architectures where components use multiple devices to perform its functions.

During the software conversion process 110 using, for example, either a split-mode or a rolling approach, the devices are systematically converted to the new software so that at all times some of the devices are operational either with the new software or the old software, so that service by the cluster proceeds uninterrupted. In either approach, the conversion begins at block 112 for the first device or devices to be converted. At block 114, the new software, which may be an upgrade or a downgrade to the current software, is installed in the memory 40 of the device or devices being converted. Once the software is installed, control passes to block 116 wherein the device or devices are removed from service in preparation for switching to execution of the newly installed software.

Once the software is installed and the device or devices are removed from service, the services of the device or devices are de-registered from the name services 96-102 of the devices 30-36 in the cluster at block 118. At block 118, the registries of the name services 96-102 are updated to prevent the name services 96-102 from attempting to bind the services of the out-of-service device or devices to a client that is requesting the services. Because these services are temporarily unavailable, the registries of the name services 96-102 must also be updated with alternative services to which the clients will be bound. For global services, the registries of the name services 96-102 may be updated to bind clients to the global services on any of the other devices 30-36 in the cluster. For local services, however the name services 96-102 are updated to bind the clients to local services either on the same device or to local services within the same local domain. This ensures that the clients are bound to local services operating under a compatible version of software.

While the install software block 114, removal block 116, and de-registration block 118 are shown herein as occurring in the order shown, persons skilled in the art will understand that, depending on the devices, software and preferences of those performing the conversion, the devices may be removed from service and the services de-registered prior to installing the new software release. For example, it may be necessary to remove a device from service before installing the new software if the old software is being overwritten by the new software. Moreover, the removal from service and de-registration steps may occur concurrently. Those skilled in the art will understand that the order of performing these steps may vary for a specific implementation with departing from the method of the present invention.

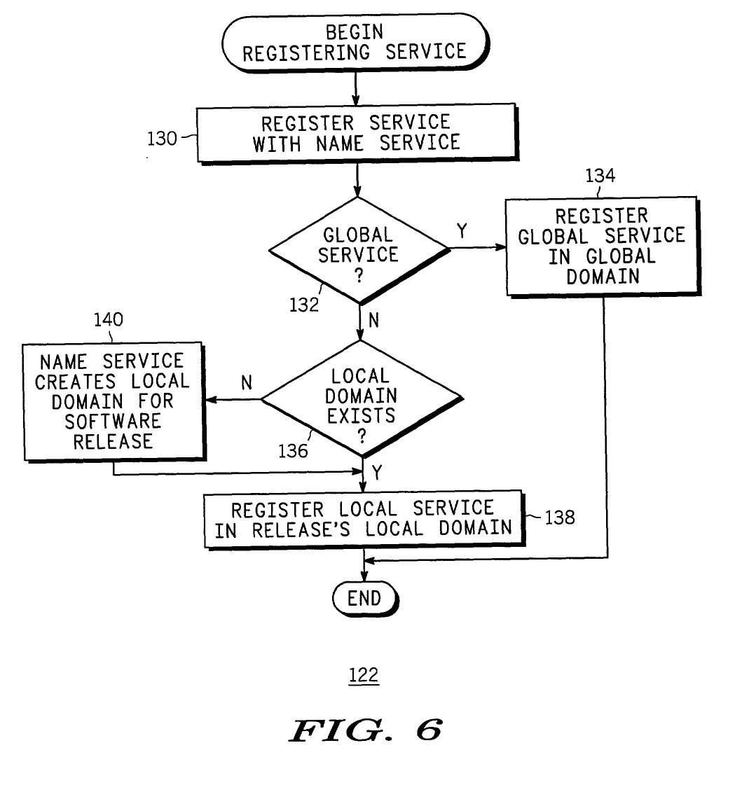

After installing the software, removing the device or devices from service, and de-registering the services, the converted device or devices are restarted or rebooted and placed back into service at block 120. At this point, the client applications and services of the device or devices are operating under the new software version. Once the devices are back in service, control passes to block 122 wherein the converted services are registered in the name services 96-102 within the proper domain. The registration process for the converted services is discussed in detail hereinafter with reference to the flow diagram of FIG. 6. After the registration at block 122, control passes to block 124 to determine whether all the devices of the cluster have been converted. If not, control passes to block 126 to begin the conversion of the next device or devices, and the conversion proceeds as discussed above. If all devices have been converted, the conversion process ends with all local services having been shifted to the new local domain.

As previously discussed, the flow diagram at FIG. 6 illustrates the process for registering services 122 of the converted device or devices in the name services 96-102. The registration of each service begins at block 130. If the service is a global service, block 132 passes control to a block 134 to register the global service in the global domain. The registries of the name services 96-102 are updated with information that will cause the name services 96-102 to bind the global services to clients upon receiving requests for the global services. The information stored in the registry for the global service may include the device on which the global service resides, an indicator that the service is a global service, a catalog of the services provided by the global service, and any other information necessary for the name services 96-102 to bind a requesting client to the service.

If the service being registered is a local service, control passes to block 136 to determine whether a local domain exists for the new software version. If a local domain exists, i.e. other local services operating under the new software version are already registered, then control passes to block 138 to register the local service with the name services 96-102 in the appropriate local domain. The registration would include updating the registries of the name services 96-102 with information similar to that for the global service described above, along with additional information the local domain in which the local service resides.

If a local domain does not exist for the new software version, the control passes to block 140 wherein the name services 96-102 create a new local domain for the new software version using information for the release provided by the local service. Once the new local domain is created, control passes to block 138 to register the local service in the local domain in the manner described above. Once the local service or global service is registered at blocks 138 or 134, respectively, the registration process 122 is complete. While the creation of the new local domain is described herein as a discrete step, the creation of the local domain may occur implicitly and logically with the registration of the first service operating under the new software release.

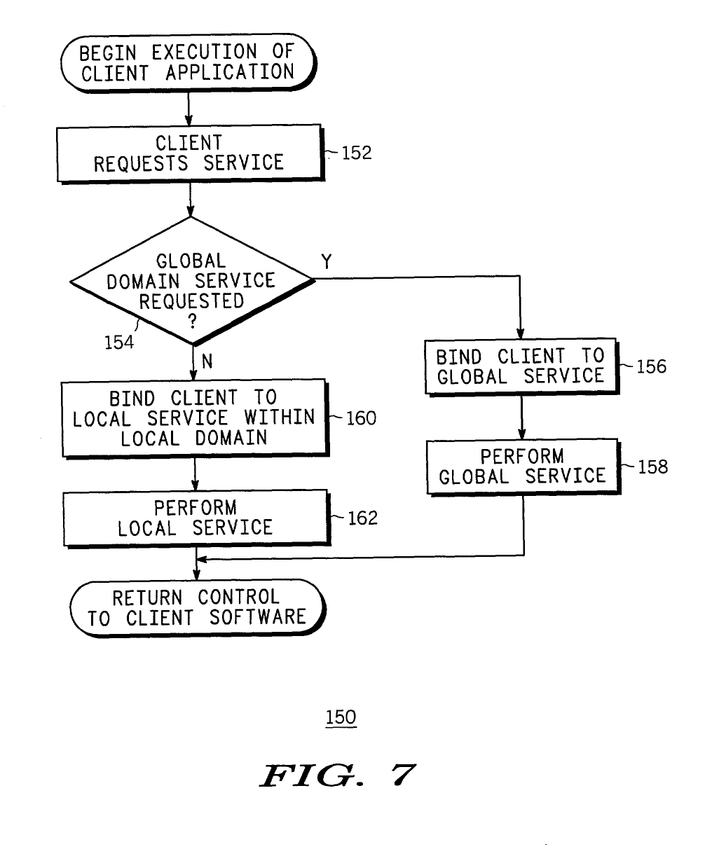

While the software conversion is proceeding with some devices operating under the old software version and the remaining devices operating under the new software version, client requests for services may be processed according to the method of the present invention via the process 150 illustrated in FIG. 7. The process 150 begins at block 152 when the client requests a service provided by a global or local service provided by a device within the cluster. The client transmits the request to the name service of its device, which will bind the client to the appropriate service for processing the request. At the block 154, the name service determines whether the client has requested a global service based on the information stored in the registry of the name service. If a global service has been requested, control passes to block 156 wherein the name service binds the requested global service to the requesting client. As previously discussed, the global service may be performed at any device within the cluster, even if the device and, hence, the global device operate under a different software version. If the versions differ, any compatibility issues are handled by code either in the global service software, or in the device of the requesting client and possibly contained in the name service. Once bound to the requesting client by the name service, the request is delivered to the global service, which performs the requested global service at block 158. Once the global service is performed, control returns to the client.

If a local service is requested, control passes from block 154 to block 160 at which the name service binds the requesting client to the local service within the local domain for the client's software version. As with the global services, the name service determines the local service to which to bind the requesting client from the information relating to the requested service stored in its registry. However, because multiple local domains may exist, the name service must determine the appropriate local service in the appropriate local domain for the client application software. The name service does this by utilizing information relating to the software release installed on the device and under which the requesting application is operating. For example, when a client application requests services, the client application may pass additional information indicating its software release for use by the name service in identifying the local domain and local service to which the client will be bound. Alternatively, the name service may be configured to use information identifying its own software release to identify the local domain and local service upon receiving the request from the client application. Once the appropriate local service and local domains are determined, the name service binds the requesting client to the local service and control passes to block 162 wherein the local service performs the requested service. Once the local service is performed, control returns to the client.

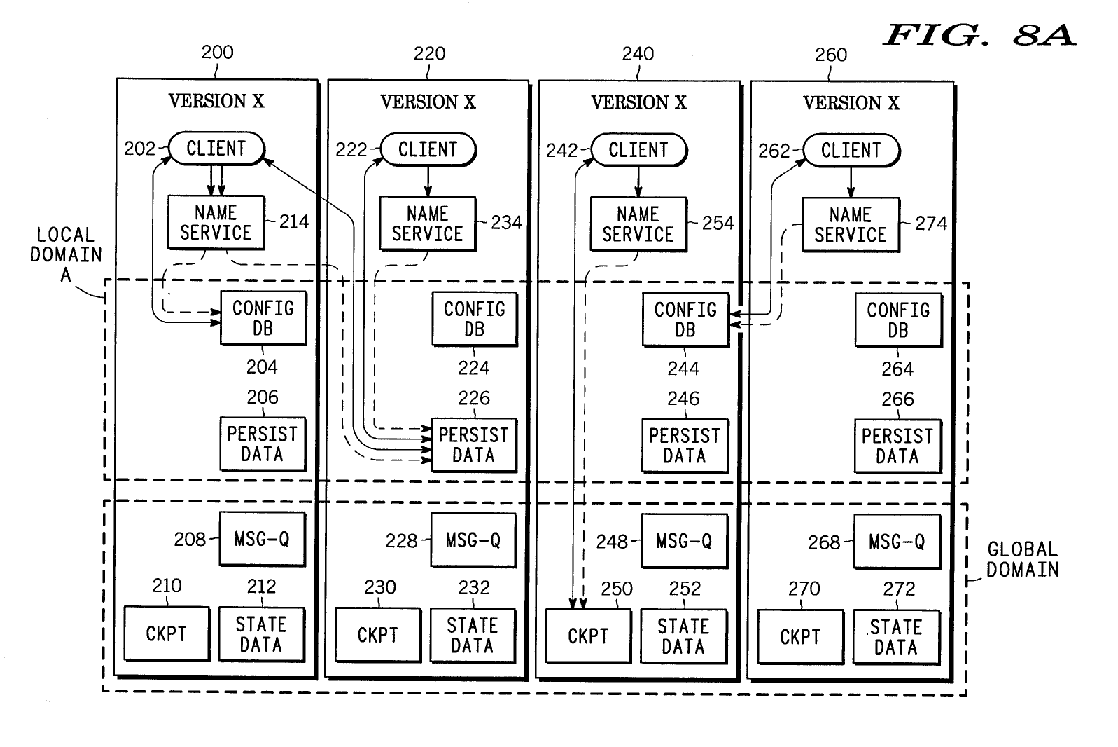

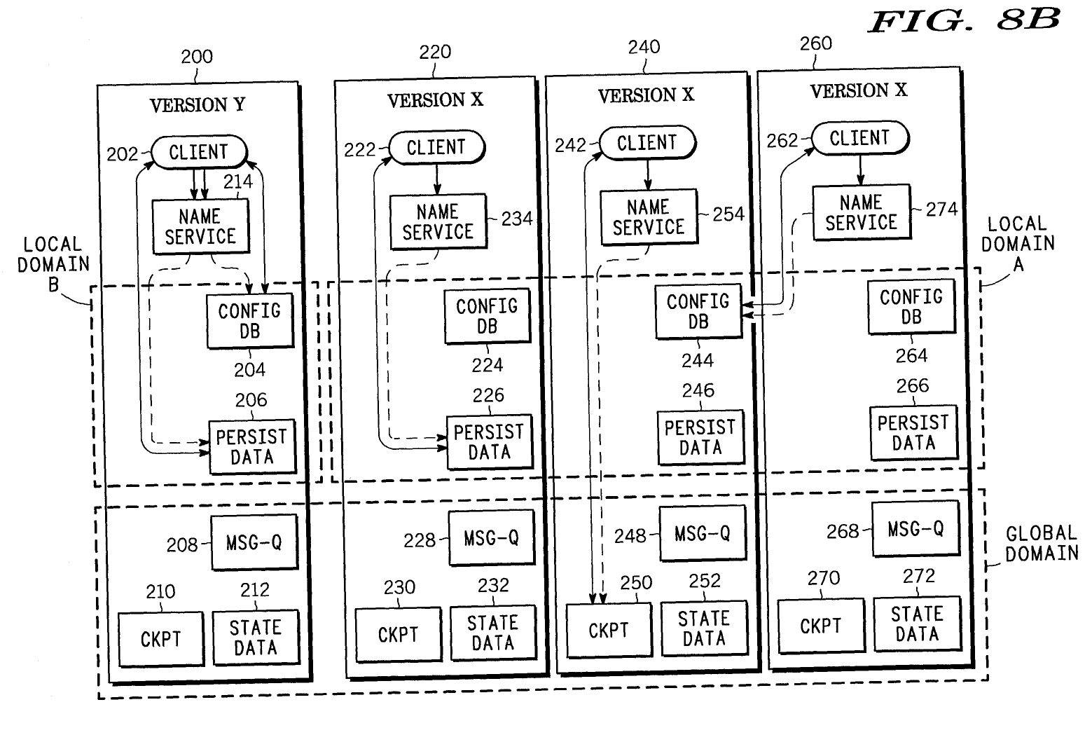

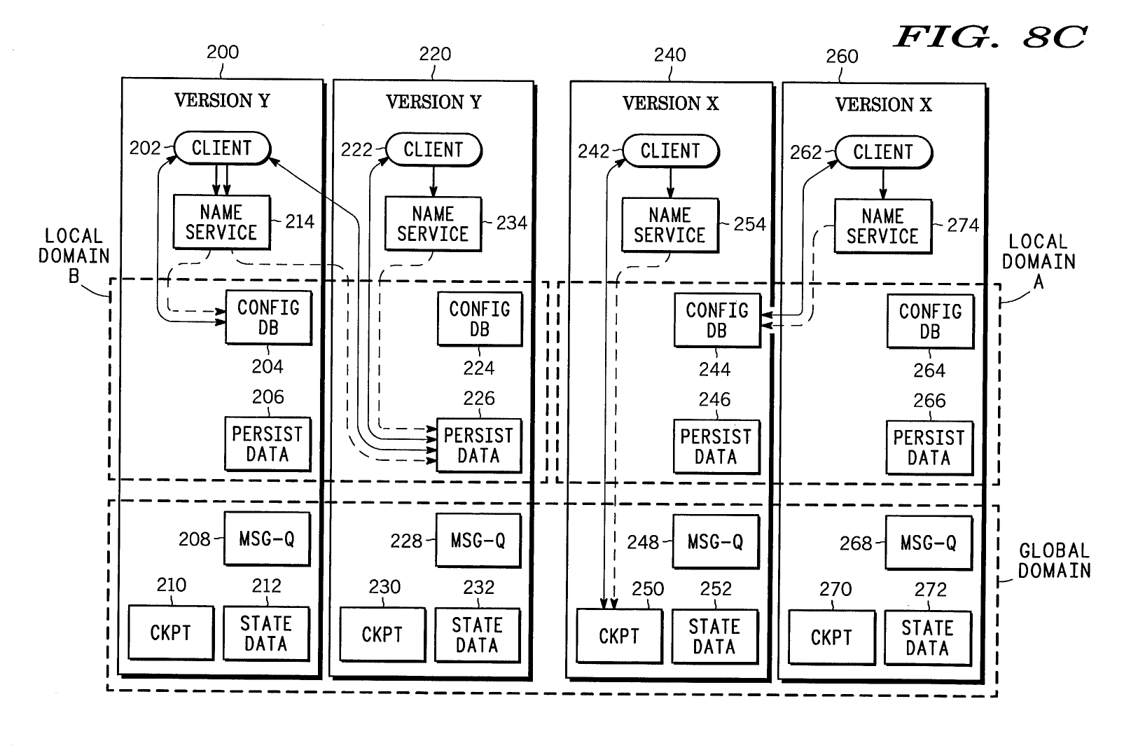

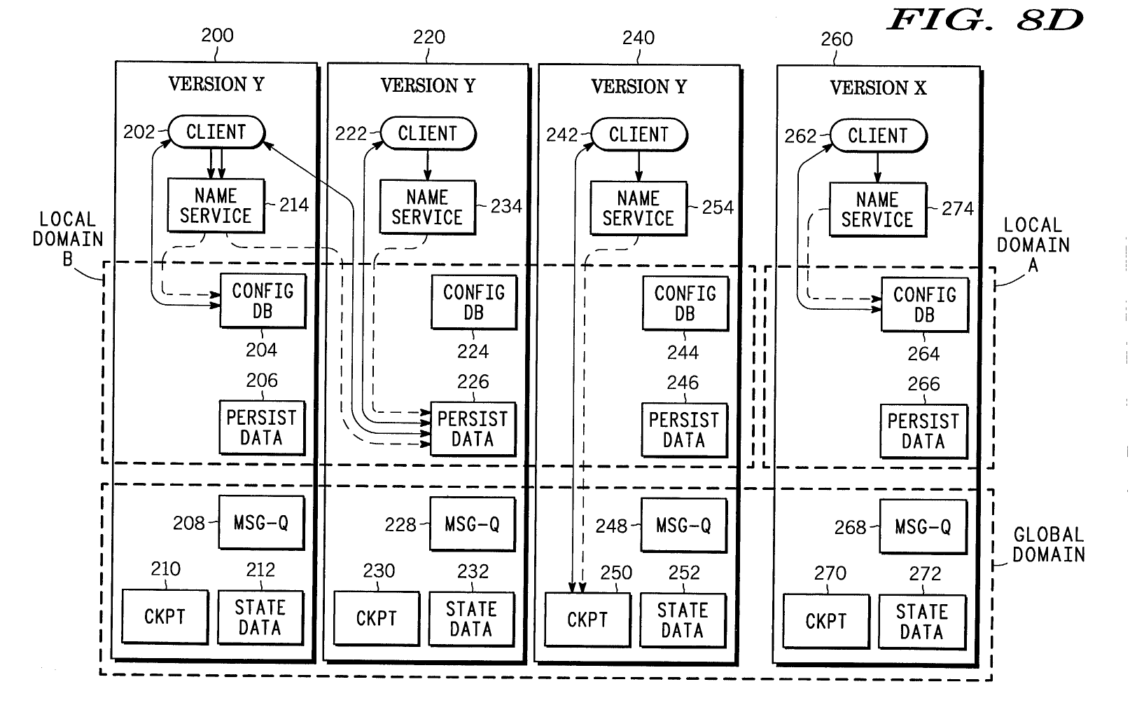

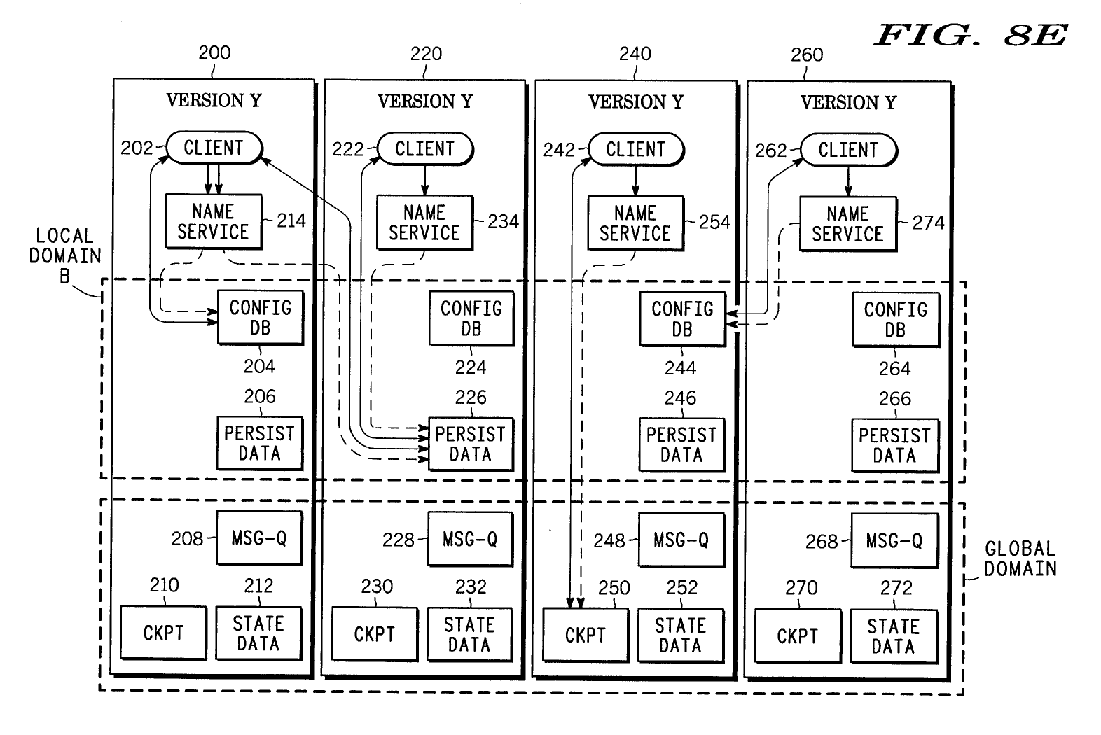

FIGS. 8a-e illustrate an example of a cluster of devices that may implement the method of the present invention during a software conversion. Devices 200, 220, 240, 260 may be, for example, a set of processors in the BTS 14 of FIGS. 1-2 that perform call processing in the cellular environment over which the load of calls is distributed. The devices 200, 220, 240, 260 may include one or more client applications 202, 222, 242, 262 that issue requests for various services that are available in the cluster. The services may include, for example, logical de-centralized services, such as configuration database access 204, 224, 244, 264, and persistent data access 206, 226, 246, 266, and logically centralized services such as message passing 208, 228, 248, 268, checkpoint data access 210, 230, 250, 270, and state data access 212, 232, 252, 272. A particular service requested by one of the clients 202, 222, 242, 262 may be provided by a local or global service on the same device 200, 220, 240, 260 or by a service on a different device 200, 220, 240, 260 in the cluster. In order to direct the requests of the clients 202, 222, 242, 262 to the appropriate services, name services 214, 234, 254, 274 of the devices 200, 220, 240, 260 include registries of the services offered by the devices 200, 220, 240, 260 in the cluster. For example, client 202 may make a request for services provided by the configuration database access service 204 in its own device 200. The name service 214 receives the request from client 202, determines from the registry that configuration DB access service 204 provides the requested service, and binds the service 204 to the client 202. The configuration DB service 204 processes the request and, upon completion, passes control back to the client 202 directly.

As another example, client 202 may request a service provided by the persistent data access service 226 of device 220. When the name service 214 receives the request from client 202, the registry causes the name service 214 to bind the persistent data access service 226 to client 202 via the cluster's intranet. The persistent data access service 226 performs the requested service and, upon completion, passes control back to the client 202 over the intranet.

Under normal operating conditions, the cluster operates in the manner described above to, in this example, handle call processing in the cellular environment. As shown in FIG. 8a, each of the devices 200, 220, 240, 260 is operating with software version X and, therefore the client application 202, 222, 242, 262, and global and local services are compatible across the devices 200, 220, 240, 260 and interact in the manner described above. Complexity arises during phased software conversions of the devices 200, 220, 240, 260 in the cluster. As the conversion progresses, devices 200, 220, 240, 260 concurrently operate with different versions of software so that service is maintained throughout the conversion. In previous cluster implementations, all services, whether logically centralized or de-centralized, addressed as global services for the purposes of software conversion, with additional code required whenever a service operating under one software version was incompatible with client applications operating under a different software version. The additional code is, at a minimum, reduced by implementing the method and apparatus of the present invention to segregate logical de-centralized local services into local domains based their software version. Thus segregated, their services may be provided to client applications operating under compatible software versions.

Referring now to FIG. 8b, device 200 has been converted to software version Y via a conversion process, such as the process described in relation to FIG. 5, and registered with the name services 214, 234, 254, 274 via a registration process such as the one shown in FIG. 6. As illustrated in FIG. 8b, new local domain B has been created in the registry of the name services 214, 234, 254, 274 and includes configuration DB access service 204 and persistent data access service 206. The previously described request by client 202 for service provided by configuration DB access service 204 is processed in the manner previously described. However, the services requested by client 202 and previously provided by persistent data access service 226 are not provided by persistent data access service 226 because version Y of the client software is not necessarily compatible with version X of the logically de-centralized services. Instead, the registry of name service 214 now directs the request of client 202 to the persistent data access service 206 having compatible software version Y and residing in local domain B. Therefore, when name service 214 receives the request from client 202, the name service 214 binds persistent data access service 206 to client 202, persistent data service 206 processes the request, and upon completion passes control back to client 202. By manipulating the registry of the name service 214 to direct the request of client 202 to a local service in the appropriate local domain B, the need for additional software to ensure compatibility between the old version of the service and the new version of the client application software is eliminated.

Turning to FIG. 8c, device 220 has been converted to software version Y and its services 224, 226, 228, 230, 232 have been registered in the name services 214, 234, 254, 274. The local services 224, 226 of device 220 are now registered in local domain B. Consequently, the original processing flow between client 202 and persistent data access service 226 shown in FIG. 8a can be restored since the client 202 and persistent data access service 224 now operate under software version Y.

The rollout of the new software continues at FIG. 8d with the conversion of device 240 to software version Y and with the registration of its local services 244, 246 in name services 214, 234, 254, 274. Because configuration DB access service 244 and persistent data access service 246 now reside in local domain B, client 262 operating with software version X cannot obtain services from configuration DB access service 244. Although name service 274 remains on device 260 and still operates with software version X, the registry of name service 274 has been updated to direct the configuration DB access request of client 262 previously serviced by configuration DB access service 244 to configuration DB access service 264 operating under the same software version X and residing in local domain A. It can be noted, however, that certain non-critical services may queued up or, in some situations, discontinued during the conversion of the cluster for the period of time that a given client and requested local services are operating under incompatible versions of software. Once the client and service are both converted to the new version of the software, the service may be resumed and any queued up requests can be processed.

FIG. 8e illustrates the cluster of devices 200, 220, 240, 260 after the conversion to software version Y is complete. Post-conversion, all the local services of the devices 200, 220, 240, 260 reside within local domain B, and name services 214, 234, 254, 274 direct requests for services from the clients 202, 222, 242, 262 to the services of the devices 200, 220, 240, 260 in the same manner as shown in the pre-conversion illustration at FIG. 8a.

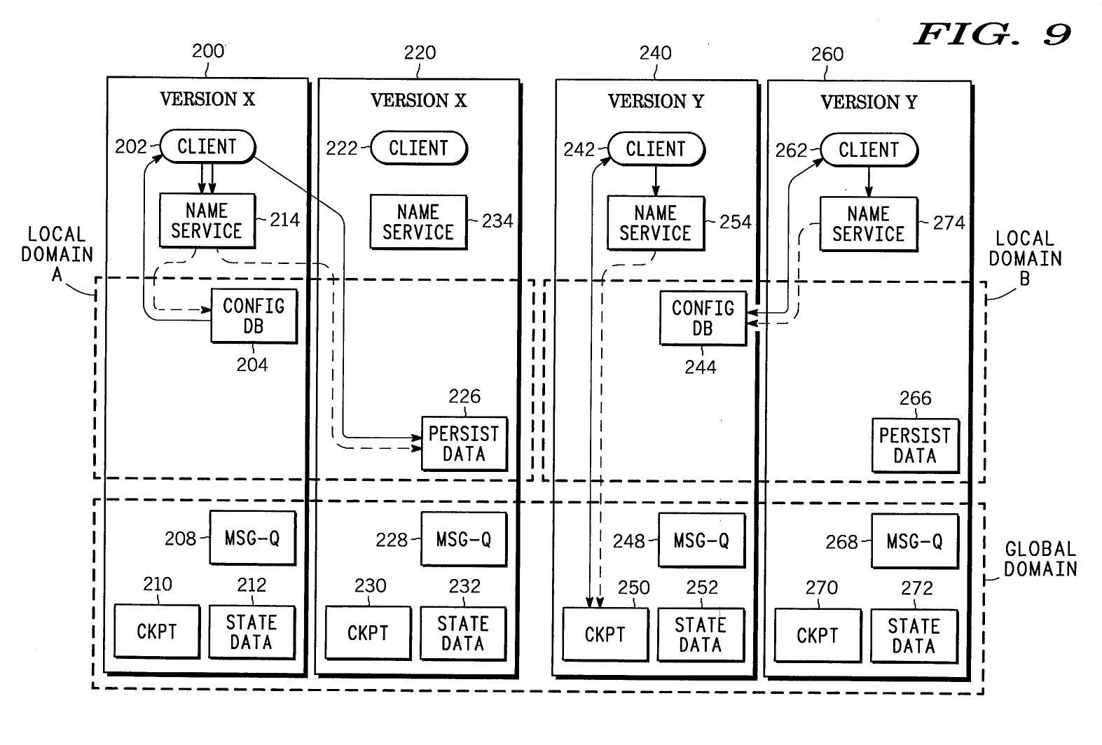

FIG. 9 illustrates an example where a split-mode conversion approach implementing the method of the present invention is used to convert the cluster of devices 200, 220, 240, 260 from software version X to software version Y. In this example, devices 200, 220 are primary devices that are normally active, and devices 240, 260 are secondary redundant back up devices that normally are on standby in the event of a failure of one or both devices 200, 220. In addition, the operations of the cluster may be divided between the devices 200, 220, 240, 260 such that, for example, devices 200, 240 perform billing functions and devices 220, 260 handle call processing. Moreover, the local services offered by the devices 200, 220, 240, 260 are distributed such the devices 200, 240 provide configuration DB access services 204, 244 and devices 200, 260 provided persistent data access services 226, 266. As a result, it is necessary to convert the primary devices 200, 220 together and the secondary devices 240, 260 together in a split-mode approach to ensure uninterrupted service from the cluster. As shown in FIG. 9, the secondary devices 240, 260 have been converted first to software version Y while the primary devices 200, 220 remain operational, with the local services being registered in the naming services 214, 234, 254, 274 as residing in new local domain B. Once converted, secondary devices 240, 260 may be switched to active mode to perform the functions of the cluster during the conversion of devices 200, 220 to software version Y.

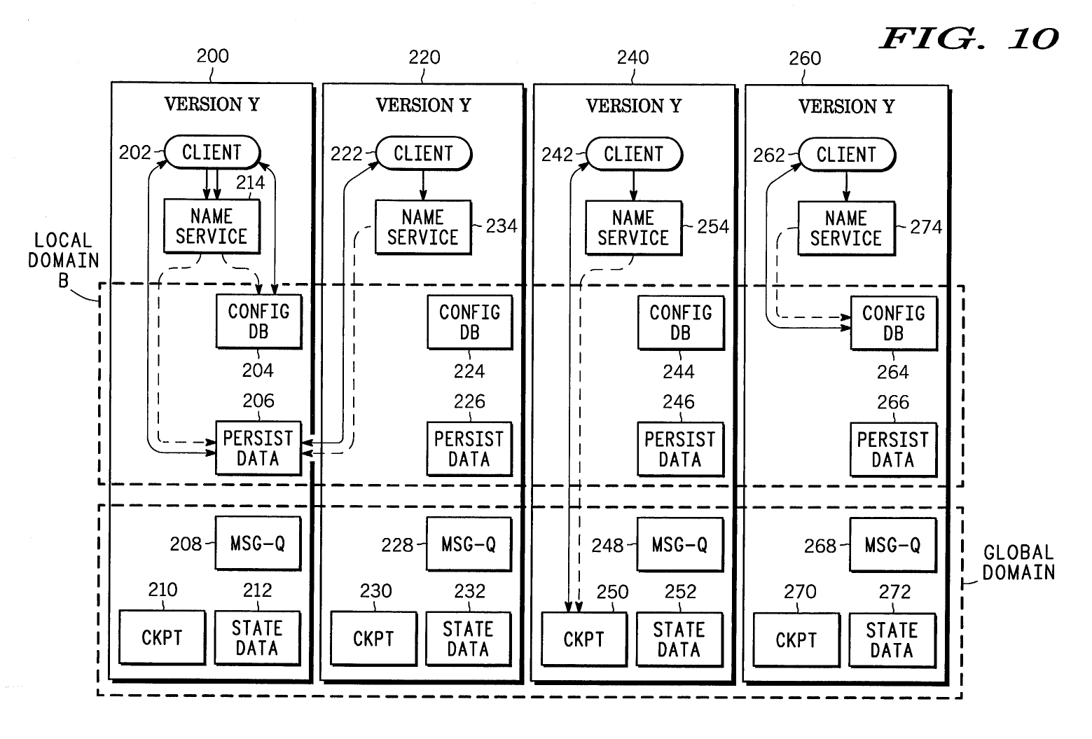

FIG. 10 illustrates an alternative conversion outcome for the cluster of devices 200, 220, 240, 260 of FIG. 8a. During the conversion, the requests from clients 202, 222 previously serviced by persistent data access service 226 are permanently re-routed to persistent data access service 206, and requests by client 262 previously serviced by configuration DB access service 244 are permanently re-routed to configuration DB service 264. This conversion strategy, which may be implemented using the method of the present invention, can reduce the necessity of performing additional data processing activity, such as synchronizing data accessed by persistent data access service 226 and configuration DB service 244 where the processing capacity of the devices 200, 220, 240, 260 permits permanent diversion of services between the devices 200, 220, 240, 260.

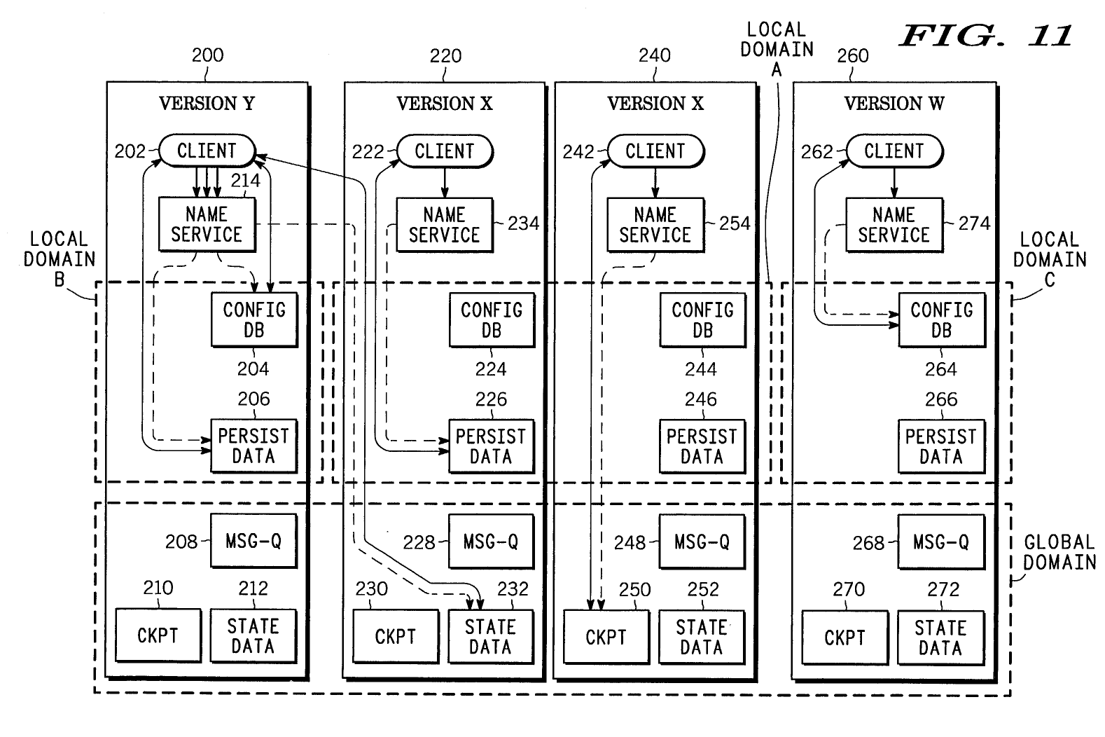

Referring now to FIG. 11, the cluster of devices 200, 220, 240, 260 are depicted in a state wherein three versions of software operate concurrently in the cluster. Such a condition may be necessitated by a particular conversion strategy, or potentially in a disaster recovery situation where it may be necessary to revert to an older software version W before reinstalling later versions X and Y. The method of the present invention allows the software versions to coexist because the registry of the name services 214, 234, 254, 274 will cause the name service 214 to bind local service requests from client 202 to local services 204, 206 on device 200, cause the name services 234, 254 to bind local service requests from clients 222, 242, respectively, to local services 224, 226, 244, 246 on devices 220, 240, and cause the name service 274 to bind local service requests from client 262 to local services 264, 266 on device 260. FIG. 11 further illustrates the situation where client 202 operating under software version Y requests global services provided by state data access service 232 operating under software version X, which may be incompatible. In this situation, additional code of the type previously described may be required for compatibility between client 202 and state data access service 232.

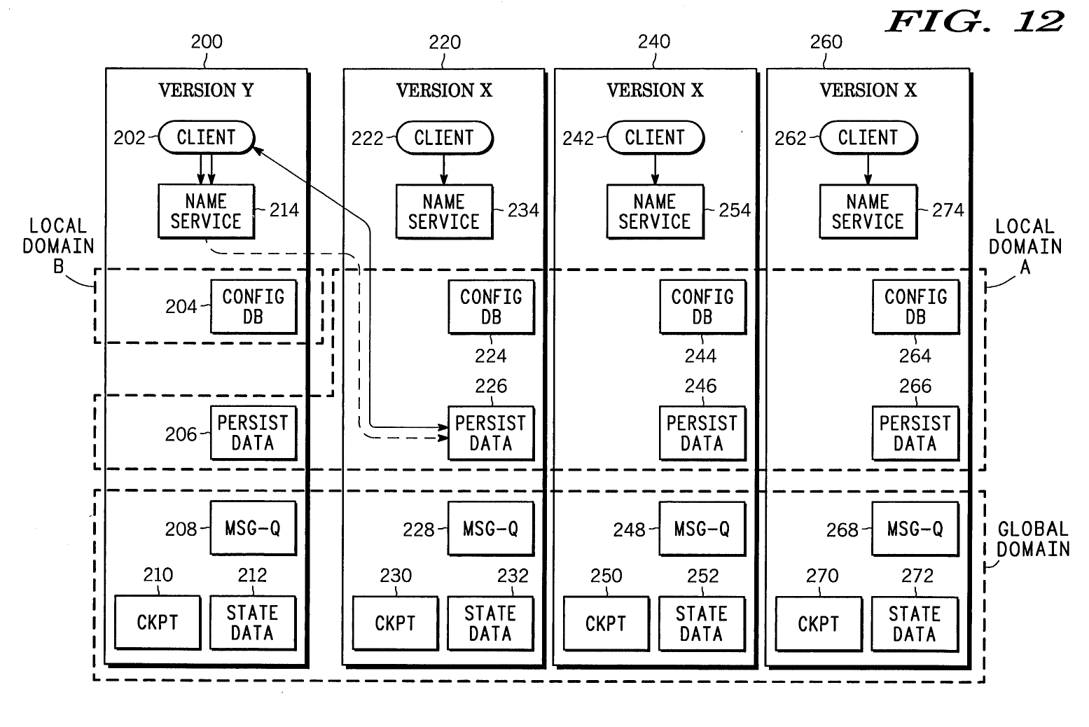

FIG. 12 illustrates a conversion in which the new version of a client application may be compatible with the old version of a local service, such as persistent data access services 206, 226, 246, 266. In such a situation, it may not be necessary to re-register the services 206, 226, 246, 266 in local domain B as they are converted since the client 202 can obtain services from persistent data access service 226 while the devices 200, 220, respectively, operate with different software versions. The existing relationship between the client 202 and persistent data access service 226 may be preserved during the conversion process by either omitting the de-registration and re-registration steps for the compatible local devices, or by re-registering the local services with the same or similar information as existed before the conversion that causes the binding of the client 202 to persistent data access service 226.

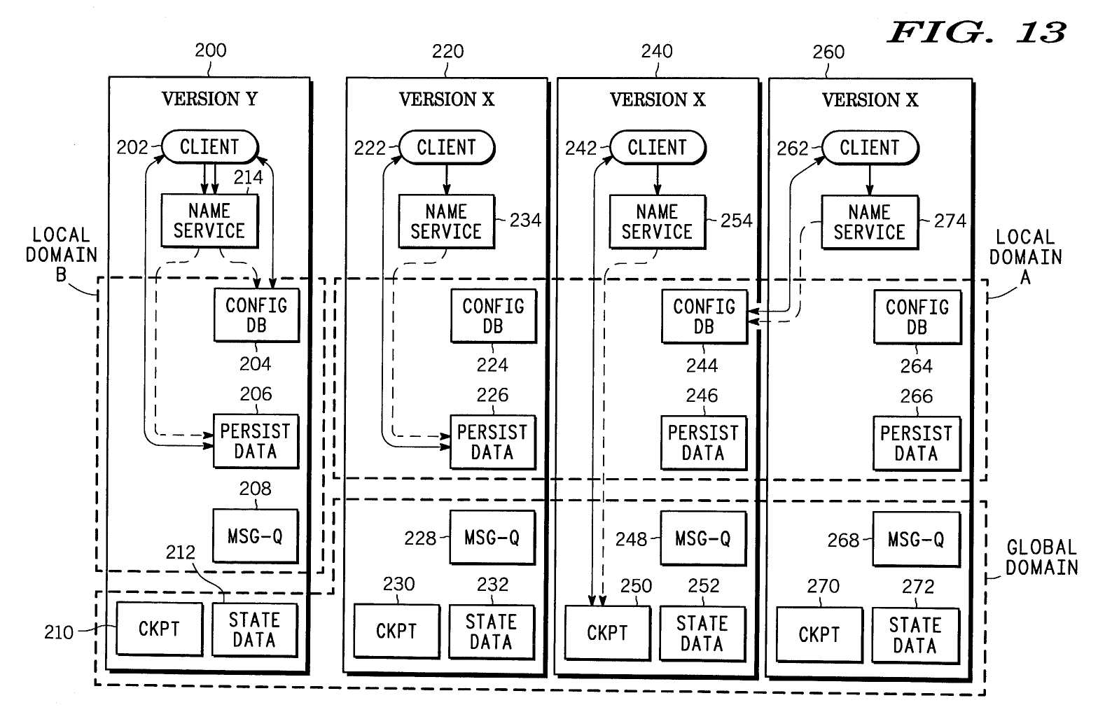

FIG. 13 illustrates yet another state in which message queue services 208, 228, 248, 268 operating as global services under software version X are converted to logically de-centralized local services under software version Y. During the conversion process in the re-registration step, the converted message queue service 208 is registered with information indicating that it is now a local service, and that it now resides within local domain B of software version Y and no longer in the global domain.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

We claim:

1. A component of a communications network capable of maintaining service interoperability during a software replacement, the component comprising:
a plurality of devices, each device comprising:
a processor coupled to the communications network;
a memory coupled to the processor;
at least one first set of instructions stored in the memory and adapted to cause the processor to perform a logically de-centralized processing function;
at least one second set of instructions stored in the memory and adapted to cause the processor to request the performance of one of the logically de-centralized processing functions by one of the first set of instructions stored in the memory of one of the devices; and
a third set of instructions stored in the memory and adapted to cause the processor to bind the second set of instructions requesting the performance of the logically de-centralized processing function to the one of the first set of instructions; and
an internal network coupled to the plurality of devices and adapted to facilitate the communication of data between the devices;
wherein during a software replacement the first and second sets of instructions of a first subset of the devices operate under a first software version and the first and second sets of instructions of the devices not in the first subset of devices operate under a second software version;
wherein the third set of instructions of the first subset of devices cause the processors of the first subset of devices to bind the second sets of instructions requesting logically de-centralized processing functions to first sets of instructions of the devices in the first subset of devices; and
wherein the third set of instructions of the devices not in the first subset of devices cause the processors of the devices not in the first subset of devices to bind the second sets of instructions requesting logically de-centralized processing functions to first sets of instructions of the devices not in the first subset of devices.

2. The component of claim 1, wherein each device further comprises at least one fourth set of instructions stored in the memory and adapted to cause the processor to perform a logically centralized processing function and the at least one second set of instructions stored in the memory further adapted to cause the processor to request the performance of one of the logically centralized processing functions by one of the fourth set of instructions stored in the memory of one of the devices, and wherein during the software replacement the third set of instructions of the devices cause the processors of the devices to bind the second sets of instructions requesting logically centralized processing functions to fourth sets of instructions of the devices.

3. The component of claim 1, wherein during the software replacement the first and second sets of instructions of a second subset of the devices operate under a third software version and the first and second sets of instructions of the devices not in the first and second subsets of devices operate under a second software version;
wherein the third set of instructions of the second subset of devices cause the processors of the second subset of devices to bind the second sets of instructions requesting logically de-centralized processing functions to second sets of instructions of the devices in the second subset of devices; and
wherein the third set of instructions of the devices not in the first and second subsets of devices cause the processors of the devices not in the first and second subsets of devices to bind the second sets of instructions requesting logically de-centralized processing functions to first sets of instructions of the devices not in the first and second subsets of devices.

4. The component of claim 1, further comprising a registry database for storing information relating to the first sets of instructions stored in the memories of the devices, and wherein the third set of instructions stored in the memories of the devices are adapted to cause the processor to determine the one of the first set of instructions to which to bind the second set of instructions requesting the performance of the logically de-centralized processing function based on information stored in the registry database.

5. The component of claim 1, wherein each of the devices further comprises a registry database stored in the memory, and wherein the third set of instructions stored in the memory of the device are adapted to cause the processor to determine the one of the first set of instructions to which to bind the second set of instructions requesting the performance of the logically de-centralized processing function based on information stored in the registry database.

6. A device in a component of a communications network, the component having a plurality of devices and an internal network coupled to the device and plurality of devices and adapted to facilitate the communication of data between the plurality of devices, wherein the component is adapted to maintain service interoperability during a software replacement of the devices from a first software version to a second software version during which a first subset of devices operates under the first software version and the devices not in the first subset operate under the second software version, the device comprising:
a processor coupled to the communications network;
a memory coupled to the processor;
at least one first set of instructions stored in the memory and adapted to cause the processor to perform a logically de-centralized processing function;
at least one second set of instructions stored in the memory and adapted to cause the processor to request the performance of one of the logically de-centralized processing functions by one of the first set of instructions stored in the memory of one of the device and one of the plurality of devices of the component via the internal network; and
a third set of instructions stored in the memory and adapted to cause the processor to bind the second set of instructions requesting the performance of the logically de-centralized processing function to the one of the first set of instructions in the memory of one of the device and the one of the plurality of devices of the component via the internal network; and
wherein during the software conversion the first and second sets of instructions of the devices operate under the first software version and the third set of instructions cause the processor to bind the second set of instructions requesting the logically decentralized processing function to first set of instructions of one of the device and one of the plurality of devices of the component operating under the first software version.

7. The device of claim 6, further comprising at least one fourth set of instructions stored in the memory and adapted to cause the processor to perform a logically centralized processing function and the at least one second set of instructions stored in the memory further adapted to cause the processor to request the performance of the logically centralized processing function by one of the fourth set of instructions stored in the memory of one of the device and one of the plurality of devices of the component via the internal network, and wherein during the software replacement the third set of instructions causes the processor to bind the second sets of instructions requesting logically centralized processing functions to fourth sets of instructions of one of the device and one of the plurality of devices of the component.

8. The device of claim 6, further comprising a registry database for storing information relating to the first sets of instructions stored in the memory of the device and in the plurality of devices, and wherein the third set of instructions is adapted to cause the processor to determine the one of the first set of instructions in the one of the device and one of the plurality of devices of the component to which to bind the second set of instructions requesting the performance of the logically de-centralized processing function based on information stored in the registry database.

9. The device of claim 6, wherein the component further includes a registry database coupled to the internal network for storing information relating to the logically de-centralized processing functions performed by the first sets of instructions stored in the memory of the device and in the plurality of devices, and wherein the third set of instructions stored in the memory of the device is adapted to cause the processor to retrieve information relating to the logically de-centralized processing function requested by the one of the first set of instructions from registry database, and to determine the one of the first set of instructions of the one of the device and one of the plurality of devices to which to bind the second set of instructions based on information retrieved from the registry database.

10. A method of maintaining service interoperability during a software replacement in a communications network component having a plurality of devices operating with a current release of software and implementing a clustered architecture, each device being programmed with one or more applications and one or more logically de-centralized services accessed by the applications, the method comprising:
installing a new release of software on a first subset of the devices;
configuring the devices of the first subset of the devices so that applications of the first subset of devices are bound to logically de-centralized processing functions on the first subset of devices upon requesting logically de-centralized processing functions; and
configuring the devices not in the first subset of the devices so that applications on devices not in the first subset of devices are bound to logically de-centralized processing functions on devices not in the first subset of devices upon requesting logically de-centralized processing functions.

11. The method of claim 10, further comprising repeating the installing and configuring steps until the new release of software is installed on all the devices.

12. The method of claim 10, wherein the installing step comprises installing the new release of software on one-half of the devices.

13. The method of claim 10, wherein the installing step comprises installing the new release of software on one of the devices.

14. The method of claim 10, wherein each device has a name service being adapted to bind an application to a logically de-centralized processing function upon receiving a request from the application for the logically de-centralized processing function, the configuration of the first subset of devices comprising configuring the name service of each device in the first subset of devices so that applications of the first subset of devices are bound to logically de-centralized processing functions on the first subset of devices upon requesting logically de-centralized processing functions, and the configuration of the devices not in the first subset of the devices step comprising configuring the name service of each device not in the first subset of devices so that applications on devices not in the first subset of devices are bound to logically decentralized processing functions on devices not in the first subset of devices upon requesting logically de-centralized processing functions.

15. The method of claim 10, wherein each of the devices includes one or more logically centralized processing functions accessed by the applications, the method further comprising the step of configuring the devices so that a application on one of the devices is bound to a logically centralized processing functions on one of the devices upon requesting logically centralized processing functions.

16. A method of maintaining service interoperability during a software replacement in a component of a communications network having a plurality of devices connected by an internal network, each device having at least one application and at least one local service being configured to perform at least one logically de-centralized processing function and wherein an application requests performance of a logically decentralized processing function performed by one of the local services of one of the devices of the component, and wherein during the software replacement a first subset of devices operates under the first software version and the devices not in the first subset operate under the second software version, the method comprising:
requesting the performance a logically de-centralized processing function, the request being issued by an application of one of the first subset of devices;
determining which local service of the first subset of devices performs the logically de-centralized processing function requested by the application;
binding the application requesting the logically de-centralized data function to the local service of the device of the first subset of devices providing the logically decentralized processing function; and
performing the requested logically de-centralized processing function at the local service of the device of the first subset of devices.

17. The method of claim 16, further comprising:
requesting the performance a logically de-centralized processing function, the request being issued by an application of a device not in the first subset of devices;
determining which local service of the devices not in the first subset of devices performs the logically de-centralized processing function requested by the application; and
binding the application requesting the logically de-centralized data function to the local service of the device not in the first subset of devices providing the logically de-centralized processing function; and
performing the requested logically de-centralized processing function at the local service of the device not in the first subset of devices.

18. The method of claim 16, wherein each device further includes at least one global service being configured to perform at least one logically centralized processing function and wherein an application requests performance of a logically centralized processing function performed by one of the global services of one of the devices of the component, the method further comprising:
requesting the performance a logically centralized processing function, the request being issued by one of the applications;
determining which global service performs the logically centralized processing function requested by the application; and
binding the application requesting the logically centralized data function to the global service of the device providing the logically centralized processing function; and
performing the requested logically centralized processing function at the global service of the device.

19. The method of claim 16, wherein the component further includes a registry database for storing information relating to the logically de-centralized processing functions performed by the local services of the devices, the method further comprising:
retrieving information from the registry database relating to the logically decentralized processing function requested by the application of the one of the first subset of devices; and
determining which local service of the first subset of devices performs the logically de-centralized processing function requested by the application based on the information from the registry database.

20. The method of claim 16, wherein each of the devices further includes a registry database for storing information relating to the logically de-centralized processing functions performed by the local services of the devices, the method further comprising:
retrieving information from the registry database of the one of the first subset of devices relating to the logically de-centralized processing function requested by the application of the one of the first subset of devices; and
determining which local service of the first subset of devices performs the logically de-centralized processing function requested by the application based on the information from the registry database of the one of the first subset of devices.

21. The method of claim 16, wherein each device has a name service being adapted to bind an application to a local service for performance of a requested logically de-centralized processing function upon receiving a request from the application for the logically de-centralized processing function, the method further comprising:
receiving the request being issued by the application of one of the first subset of devices at the name service of the one of the first subset of devices;
determining at the name service of the one of the first subset of devices which local service of the first subset of devices performs the logically de-centralized processing function requested by the application; and
binding by the name service of the application requesting the logically decentralized data function to the local service of the device of the first subset of devices providing the logically de-centralized processing function.
